(19) United States
(12) Patent Application Publication
(10) Pub. No.: US 2007/0239316 A1
(43) Pub. Date: Oct. 11, 2007

(54) Control system and method for environmental systems

(76) Inventors: Jeff Jelinek, Hammond, IN (US); Ryan Hardesty, Chesterton, IN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/391,360

(22) Filed: Mar. 29, 2006

(51) Int. Cl. G05D 23/00

(52) U.S. Cl. 700/276

(57) ABSTRACT

A control system and method for environmental devices such as heating and cooling devices provides a control system for controlling the environmental device. The control system has a first condition sensor for sensing a first condition of the environment, a memory for recording the sensed first condition at predetermined intervals, a clock associated with the controller that supplies time data, a controller for activating and/or deactivating the environmental device, a memory for storing data relating to the sensed condition, data relating to events of activating and/or deactivating the environmental device and time data, and a processor that controls the activation and deactivation events of the controller based on data including the stored time, activation event, and condition data.

### FIELD OF THE INVENTION

The invention pertains generally to control systems, and more particularly relates to control systems used to control environmental systems such as, for example, heating, cooling and ventilation systems.

### BACKGROUND OF THE INVENTION

Environmental systems such as, for example, heating, cooling and ventilation systems, are in wide use throughout the world. Such systems are typically used to maintain a desired condition, such as the temperature, for example, inside a building or other enclosed area. These systems range from a wide variety of types and sizes, including, for example, hot water circulating systems, forced air furnace systems, radiant heating systems, air conditioning systems, evaporative chillers, and a wide variety of other types of environmental systems. Besides heating and cooling systems, which address the temperature of the environment, other systems may affect other conditions of the environment including, for example, providing a desired humidity level, and even providing lighting, sound, or other environmental qualities.

In the particular case of heating and cooling systems, these systems typically are controlled by one or more thermostats. The thermostat has a temperature sensing device and reads a temperature at its location and compares the read temperature to a desired setting that has been input. If the read temperature is different than the desired set temperature, the thermostat will turn on, or activate, a suitable heating or cooling device, usually but not always located somewhere else in the building.

A single building may have a number of different rooms and each room can be thought of as a separate zone, or different rooms can be combined into zones. It has been known to put different, or separate, thermostats in different zones, and different, or separate, heating or cooling systems associated with each zone, and then have the respective thermostat send controls to the system for that zone to adapt the system so that each zone is maintained at or near a desired temperature.

However, the above described zone thermostat-based temperature control systems still have some disadvantages. In particular, each zone often has its own particular factors which affect its temperature over time. For example, some zones may be poorly insulated and therefore require frequent temperature change cycles. A thermostat that simply turns on and off at a predetermined temperature may not thus activate the system in the most efficient way.

Further, many buildings are in locations that have seasonal temperature differences, or even continual load differences during the course of the day, and in such cases a thermostat that simply turns on and off at a predetermined sensed temperature may not most efficiently adapt to the particular external weather conditions at a given time.

In view of the foregoing, it would be desirable to have a control system that can overcome the above mentioned disadvantages to at least some extent, and provide a control system and method for environmental systems, for example, heating and cooling systems, that is more advanced than a simple on/off thermostat.

### SUMMARY OF THE INVENTION

The foregoing needs are met, to a great extent, by the present invention, wherein in one aspect an apparatus and method is provided that in some embodiments provides a control system and method for environmental systems, for example, heating and cooling systems, that is more advanced than a simple on/off thermostat.

In accordance with one aspect of an embodiment of the present invention, a control apparatus for controlling an environmental device, the control system comprising a first condition sensor that senses a first condition of the environment, a first memory that records the sensed condition at predetermined intervals, a controller configured to activate and/or deactivate the environmental device, a clock associated with the controller that supplies time data, a second memory that records the sensed condition data, the events of activating and/or deactivating the environmental system, and time data, and a processor that controls the activation and deactivation events of the controller based on data including at least one of the stored time, activation event, and condition data.

In accordance with another aspect of an embodiment of the present invention, a method for controlling an environmental device comprising sensing a first condition of the environment, recording the sensed condition at predetermined intervals, controlling the environmental device by activating and/or deactivating the environmental device, supplying time data storing the sensed condition data, the events of activating and/or deactivating the environmental system and time data, and controlling the activation and deactivation based on data including at least one of the stored time, activation event, and condition data.

In accordance with yet another embodiment of the present invention, a control system for controlling an environmental device, the control system comprising means for sensing a first condition of the environment, means for recording the sensed condition at predetermined intervals, means for activating and/or deactivating the environmental system, means associated with the controller for supplying time data, means for storing the sensed condition data, the events of activating and/or deactivating the environmental system and timed data, and means for controlling the activation and deactivation events of the controller based on data including the stored time, activation event, and condition data.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a zone of a building, showing heat losses and heat additions into the zone.

FIG. 2 is a schematic diagram of a control system for controlling a multiple zone environment, according to a preferred embodiment of the invention.

### DETAILED DESCRIPTION OF THE INVENTION

Various embodiments of the present invention can provide an improved control system and method for controlling environmental devices. The example given below will be described in the context of heating and cooling of a building, but it should be appreciated that other embodiments of the invention may be used to control systems that provide other inputs into buildings or other environments, such as for example, humidity, lighting, ventilation, sound, or other ambient qualities.

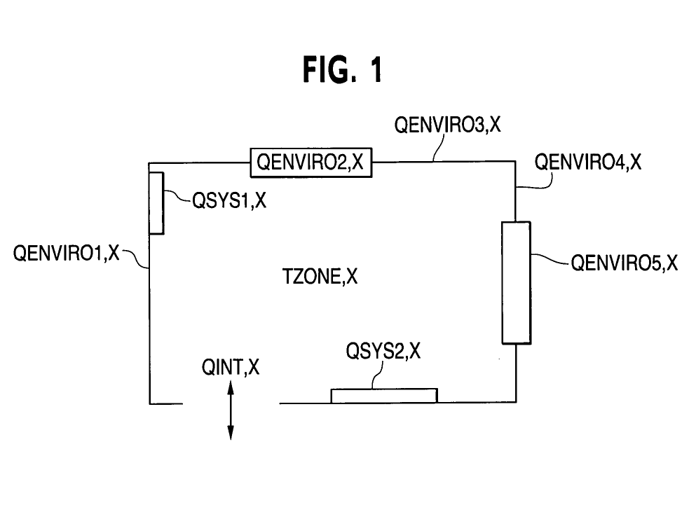

Turning now to FIG. 1, this schematic diagram illustrates heat loses and heat additions in an example zone designated zone “x”. The zone has a temperature in the center of the zone indicated as Tzone,x. A positive or negative heat addition is put into the building by a system designated as Qsys1,x, which could be for example a heating system (positive Q) or a cooling (air conditioning) system (negative Q). The zone also has a second system which adds positive or negative heat Qsys2,x.

The zone is located adjacent another zone and intermediate heat may be transferred by zone x via a pathway Qint,x. For this example, the zone is being maintained in a warmer temperature than its surrounding environment (e.g., in this example a heating system is described).

The zone also loses heat to (or receives heat from) the environment through regions and processes designated as Qenviro1,x, Qenviro2,x, Qenviro3,x, Qenviro4,x, and Qenviro5,x. Examples of such heat loss or gain may be through the walls indicated as Qenviro1,x, Qenviro3,x, and Qenviro4,x and through windows indicated as Qenviro2,x and Qenviro5,x.

The degree of insulation, type, and thermal gradient between the zone and its surrounding areas will all determine the speed and degree of heat loss through these processes. The rates of heat loss for each of these may change during the day, for example, in the case of windows which are subjected to sunlight a part of the day but not others. Further, in the case of heat loss through walls, if these walls connect to another zone or connect to another building, the heat loss through these zones may change during different times, in fairly regular and periodic ways in some cases for. For example, a neighboring adjacent building, room, or zone may have its own periodic temperature profile due to its own usage pattern or other factors.

Some embodiments of the present invention provide a control system which monitors and tracks the heating and cooling input patterns and resulting actual zone temperature so that the system can anticipate heating and cooling needs and then provide control inputs that are tailored to anticipate these requirements and provide the most efficient system.

Using the example shown in FIG. 1, it will be appreciated that the heat lost or gained from the environment can be described by the following equation:

The Heat Lost/Gained from the Heating/Cooling System:
Q_{enviro,x}=fcn (ΣRₓ, ΣAₓ, Tₒᵤₜ, Qₛₒₗₐᵣ, V_{wind}, Date, Time, System History)

R=Thermal Resistance of the enclosure media. Setup input from user.

A=Area of the enclosure media. Setup input from user.

Tₒᵤₜ=Outdoor air temperature. Measured via external sensors.

Qₛₒₗₐᵣ=Amount of solar radiation. Measured via external sensors.

V_{wind}=Velocity of the wind. Measured via external sensors.

Date=Day of week, day of year. Different seasons/days of week require different heating/cooling systems responses due to annual weather patterns, Sun bearing/inclination, occupancy, etc.

Time=Time of day. Generally less heating during day and more during evening.

System History=Cumulative database so that patterns (occupancy, annual/daily heating requirements, wind loading, etc) could be tracked and monitored so that heating/cooling system could react preemptively/accordingly to environmental demands.

The Heating/Cooling System:
Q_{sys,x}=fcn (Σ Emitter Type, ΣAₑₘᵢₜₜₑᵣ, m, T_{fluid}, ε)

Emitter Type=Type of heating/cooling emitter. Forced air ducts, baseboard, radiant tubing, etc.

Aₑₘᵢₜₜₑᵣ=Area of emitter

m=Flow rate through emitter

T_{fluid}=Temperature of fluid in emitter

ε=Efficiency of emitter

The Heat Lost/Gained from Zone to Zone:
Q_{int,x}=fcn (ΣA_{opening}, T_{zone,x}, T_{zone,adjoining zone}, m_{zone})

A_{opening}=Area of free opening between zones

T_{zone,x}=Temperature of “Zone x”

T_{zone,adjoining zone}=Temperature of the adjoining zone

m_{zone}=Fluid exchange rate between zones.

The temperature of the zone, T_{zone,x}, can be defined as a function of:
T_{zone,x}=fcn (Q_{enviro,x}, Q_{system,x}, Q_{int,x})

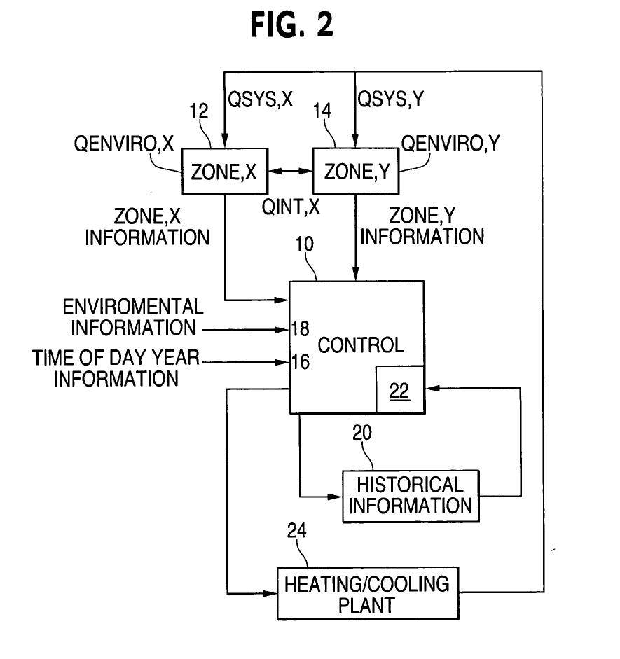

FIG. 2 depicts an exemplary embodiment of a control system 10 according to a preferred embodiment of the invention, which is shown in this example as operating in connection with two zones referred to as Zone,x and Zone,y. The control system 10 interacts with a first zone 12 designated Zone,x and a second zone 14 designated Zone,y.

The control system 10 receives information from Zone,x and also receives information from Zone,y. This information can include the temperature of each zone, as well as a record of each time the heating and cooling system(s) associated with the zone are turned on or off, and, if the heating or cooling system has different level controls, what the level setting was at the time. The control system 10 also receives time of day and calendar information via an input 16, which may be an electronic clock, and receives environmental information 18 which may be provided by external temperature, wind, light, and/or other sensors that are located in the environment surrounding Zone,x and/or Zone,y.

The control system 10 keeps track of the information for each zone and records it as well as the environmental information and the time of day and calendar information in a historical information database 20 associated with the control system 10.

The control system 10 also has a processor 22, which compares the historical information with the presently sensed information, and which provides a control output to the heating and cooling facilities or other environmental systems, here designated as 24, which provide heat inputs to each zone.

The control system 10 (also referred to herein as “controller 10”) receives these inputs and uses software to determine an appropriately efficient means of operating the heating and cooling system(s) 24 to satisfy the temperature requirements of the zone. The control system 10 may include the steps of firing of the heating system or heating plant, modulating the level of the heating plant, changing set point temperatures of the heating plant, over-firing of the plant, etc. In the case of a cooling system instead of a heating system, the controller would control similar attributes of the cooling system or cooling plant being used.

An example of such control parameters is for the system 10 to maintain a historical record of the zone temperature and the degree of (or the level of) operation of the heating system 24 over the same time. The control system 10 senses the case of a zone that loses heat only very slowly, in which case, only that a very low level of heating needs to be applied continuously to maintain a relatively even temperature. Turning to a different situation, in the case of a zone that loses heat rapidly, the control system 10 controls the heating system 24 to operate on a higher intensity level.

In another example, the control system 10 also tracks fuel consumption or electrical consumption of the heating system 24. If the heating system 24, for example, operates more efficiently at a higher level, the controller 10 instead provides control optimized to reduce fuel consumption, and thus operates the heating and cooling system 24 at a higher level on an intermittent basis. Thus, different modes such as a “comfort mode” or a “high efficiency” mode can be selected and the controller 10 optimizes the operation of the system according to the selected mode.

Another example of operation of one embodiment of the controller 10 is that the controller 10 “learns” historical periodic cycles, for example, such as seasonal and/or intra-day cycles. For example, if a zone is subjected to heat as the sun rises due to sun exposure in the morning, the controller 10 will shut off the heat supply to that zone a short time before the expected sun exposure, e.g., an hour before the sun exposure, and thus allow the zone to naturally cool a small amount before being subjected to this additional external heat gain. It will be understood that this can be an improvement over a typical attempt to maintain the zone at the set temperature where the zone would end up being warmer than is actually desired when affected by the sun, causing both an undesirable temperature spike wasting heat that might have been unnecessarily applied just before the sun exposure.

The control system 10 may comprise any suitable apparatus to carry out the desired functions described above, but in some embodiments the control system 10 includes a general purpose computer or specialty computer or programmable circuit board or other circuitry. In one example, the control system 10 includes a processor 22 which is typically a computer having a central processing unit or CPU, and associated memory devices. The CPU is typically running software designed for these purposes. In some embodiments, the software has a direct cutoff based decision making process. In other embodiments, fuzzy logic may be implemented.

Further, the system can have a learning software, where the system begins with implementation of a set program, but as it monitors the results of its operation over time, the system will intentionally vary its operation somewhat to see if the variance improves the resulting performance. If the measurement system determines that varying the program slightly has approved the performance, the learning system will implement this varied decision criteria going forward, and then, in the future will further vary it continuing to find its most optimal decision criteria for producing measured results.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A control apparatus for controlling an environmental device, the control apparatus comprising:
a first condition sensor that senses a first condition of the environment;
a first memory that records the sensed first condition at predetermined intervals;
a controller configured to activate and/or deactivate the environmental device;
a clock associated with the controller that supplies time data;
a second memory that records data relating to the sensed first condition, data relating to the events of activation and/or deactivation of the environmental device and time data; and
a processor that controls the activation and deactivation events of the controller based on data including at least one of the stored time, activation event, and condition data, and wherein the processor anticipates changes in the sensed temperature based on the stored data, and automatically based on the anticipated changes modifies its control functions without user input.

2. The apparatus of claim 1, wherein the sensed first condition is a temperature.

3. The apparatus of claim 2, wherein the sensed first condition is a temperature and the environmental device is at least one of a heating and/or cooling device.

4. The apparatus of claim 2, wherein the first condition sensor senses the temperature at regulated intervals.

5. The apparatus of claim 2, wherein the first condition sensor senses the temperature continuously.

6. (canceled)

7. The apparatus of claim 1, wherein the activation is the turning on of the environmental device and when the deactivation is the turning off of the environmental device.

8. The apparatus of claim 1, wherein the activation includes modulating a level of operation of the environmental device.

9. A method for controlling an environmental device comprising:
sensing a first condition of the environment;
recording the sensed first condition at predetermined intervals;
controlling the environmental device by activating and/or deactivating the environmental device;
supplying time data;
storing data relating to the sensed first condition, data relating to the events of activating and/or deactivating the environmental device and time data;
controlling with a processor the activating and deactivating based on data including at least one of the stored time, activation event, and condition data;
anticipating with the processor charger in the sensed structure based on the stored data; and
modifying the controlling step automatically based on the anticipated changes without user input.

10. The method of claim 9, wherein the sensed first condition is a temperature.

11. The method of claim 10, wherein the sensed first condition is a temperature and the environmental device is at least one of a heating and/or cooling device.

12. The method of claim 10, wherein the temperature is sensed at regulated intervals.

13. The method of claim 10, wherein the temperature is sensed continuously.

14. (canceled)

15. The method of claim 9, wherein the activating is the turning on of the environmental device and when the deactivating is the turning off of the environmental device.

16. The method of claim 9, wherein the activating includes modulating a level of operation of the environmental device.

17. A control system for controlling an environmental device, the control system comprising:
means for sensing a first condition of the environment;
means for recording the sensed first condition at predetermined intervals;
means for activating and/or deactivating the environmental device;
means for supplying time data;
means for storing data relating to the sensed first condition, data relating to the events of activating and/or deactivating the environmental device and time data;
means for controlling the activating and deactivating events of the controller based on data including at least one of the stored time, activation event, and condition data; and
means for anticipating changes in the sensed temperature based on the stored data; and
means for modifying the control functions of the controlling means automatically based on the anticipated changes without user input.

18. The system of claim 17, wherein the sensed first condition is a temperature.

19. The system of claim 18, wherein the sensed first condition is a temperature and the environmental device is at least one of a heating and/or cooling device.

20. The system of claim 18, wherein the sensing means senses the temperature at regulated intervals.

21. The system of claim 18, wherein the sensing means senses the temperature continuously.

22. The apparatus of claim 1, further comprising a second condition sensor that senses a second condition of the environment, and a second memory that records the sensed second condition at predetermined intervals, and wherein the second memory records data relating to the sensed second condition in addition to the sensed first condition.

23. The method of claim 9, further comprising the steps of:
sensing a second condition of the environment;
recording the sensed second condition at predetermined intervals; and
storing data related to the second sensed condition.

24. The system of claim 17, further comprising;
means for sensing a second condition of the environment;
means for recording the sensed second condition at predetermined intervals; and
wherein the means for storing data also stores data related to the sensed second condition.

25. The apparatus of claim 1, further comprising software running on the processor, which begins with implementation of a set program, and automatically varies from the set program and monitors whether the variance improves the resulting system performance.

26. The method of claim 9, further comprising the steps by the processor of implementing the set program, and automatically varying from the set program the controlling step, and monitoring whether the variance improves the resulting system performance.

27. The apparatus of claim 17, further comprising software running on the processor, which begins with implementation of the set program, and automatically varies from the set program and monitors whether the variance improves the resulting system performance.

28. The apparatus of claim 1, further comprising software running on the processor, which begins with implementation of the set program, and automatically varies from the set program and determines whether the variance improves the resulting system performance, and when improved performance is determined, adopts the varied program as a new set program.

29. The method of claim 9, further comprising software running on the steps by the processor of implementing the set program, and automatically varying from the set program the controlling step and determining whether the variance improves the resulting system performance, and when improved performance is determined, adopting the varied program as the new set program.

30. The apparatus of claim 17, further comprising software running on the processor, which begins with implementation of the set program, and automatically varies from the set program and determines whether the variance improves the resulting system performance, and when improved performance is determined, then adopts the varied program as the new set program.
